(19) United States
(12) Patent Application Publication
(10) Pub. No.: US 2012/0153099 A1
(43) Pub. Date: Jun. 21, 2012

(54) THREADED STAKE SYSTEM

(76) Inventor: CHRISTOPHER STEVEN WESOLIK, Avon, OH (US)

(21) Appl. No.: 13/323,453

(22) Filed: Dec. 12, 2011

Related U.S. Application Data
(60) Provisional application No. 61/425,414, filed on Dec. 21, 2010.

(51) Int. Cl. F16M 11/22

(52) U.S. Cl. 248/156

(57) ABSTRACT

A threaded stake system to be drilled into the ground to support construction form boards when erecting a frame. The threaded stake system comprises a stake including a shaft having a sharp tip on a first end, a polygonal shaped head on a second end, and at least one thread located near the sharp tip. The stake comprising at least one of metal, plastic, reinforced metal, reinforced plastic, polymer, fiber reinforced polymer, and composite.

### CROSS-REFERENCE TO RELATED APPLICATIONS

This application claims the benefit of priority to U.S. Provisional Application No. 61/425,414 filed Dec. 21, 2010, the contents of which are incorporated herein by reference.

### BACKGROUND OF THE INVENTION

The present invention generally relates to stakes and staking systems. More particularly, the present invention relates to stakes used in construction to temporarily hold construction forms or boards in position against the ground.

Construction form boards and stakes are commonly used to erect a frame during the preparation of a site for the placement of concrete. The current system of erecting the framing involves pounding a pointed wood stake into the ground or other support material. Unfortunately, wooden stakes do not have the strength or durability required to sustain repeated blows of a hammer and tend to rapidly disintegrate. In addition, pounding the wood stake into the ground is a very labor intensive process which causes workers physical stress and adds to labor costs.

As can be seen, there is a need for staking systems used in construction for erecting frames that are strong and reliable. In addition, there is a need for a stake that is easy to insert into the ground without causing the workers physical stress.

### SUMMARY OF THE INVENTION

In one aspect of the present invention, a threaded stake system, comprises a stake including a shaft having a sharp tip on a first end, a polygonal shaped head on a second end, at least one thread located near the sharp tip, and the stake comprises of metal, plastic, reinforced metal, reinforced plastic, polymer, fiber reinforced polymer, or composite.

These and other features, aspects and advantages of the present invention will become better understood with reference to the following drawings, description and claims.

### BRIEF DESCRIPTION OF THE DRAWINGS

FIG. 1 is a perspective view of a threaded stake system according to an exemplary embodiment of the present invention showing the threaded stake system in use;

FIG. 2 is a perspective front view of a threaded stake for the threaded stake system of FIG. 1;

FIG. 3 is a front view of the threaded stake of FIG. 2;

FIG. 4 is a perspective front view of an attachment plate for the threaded stake system of FIG. 1;

FIG. 5 is a perspective side view of the plate of FIG. 4;

FIG. 6 is a frontal view of the plate of FIG. 4; and

FIG. 7 is a cross sectional view of the threaded stake system taken along line 8-8 in FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a threaded stake system to be drilled into the ground to support construction form boards when erecting a frame.

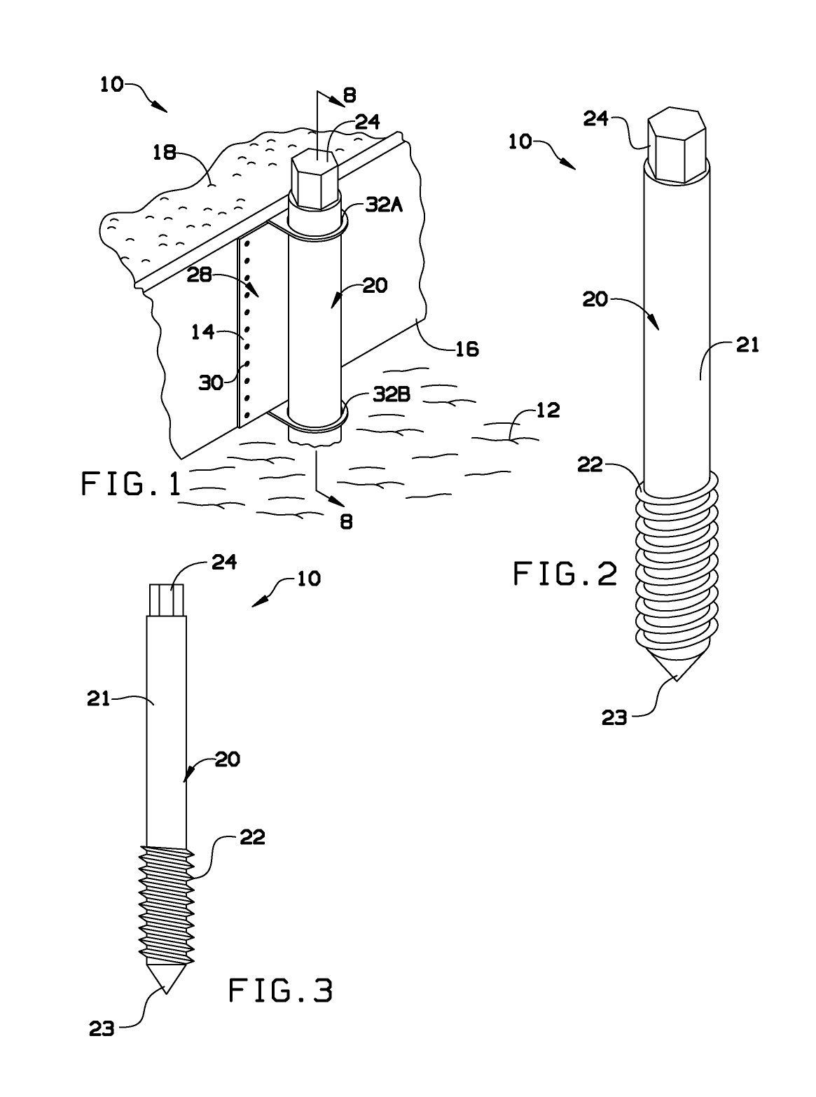

FIG. 1 shows a threaded stake system 10 according to an exemplary embodiment of the present invention. The threaded stake system 10 may be drilled into a ground 12 to support a construction form board 16 during the preparation of a site for the placement of concrete 18 when erecting a frame (not shown).

The threaded stake system 10 may include a stake 20 and an attachment plate 28.

As can be seen in FIGS. 1-3, the stake 20 may include a shaft 21 having a sharp tip 23 on one end, a polygonal shaped head 24 on the opposite end, and at least one thread 22 located near the sharp tip 23. The stake 20 may be made of a strong material, for example, metal, plastic, reinforced metal, reinforced plastic, polymer, fiber reinforced polymer, or composite. The size of the stake 20 may depend on the size of the construction form board 16. The size of the stake 20 may be, for example, approximately between 6 and 48 inches long and between ½ and 4 inches wide. The stake 20 may have a geometrical shape, for example, a cylinder having a 2½ inch diameter. The stake 20 may be made by machining, forming, injection molding, or molding.

The size of the thread 22 may depend on the size of the stake 20 and the material of the ground 12. The threads 22 may be, for example, approximately between 0.25 and 1 coarse threads per inch.

The polygonal shaped head 24 may be adapted to be used with a drill driver (not shown). The polygonal shaped head 24 may have a shape and size that matches the shape of a commercially available drill driver (not shown). The shape of the polygonal shaped head 24 may be, for example, hexagonal, pentagonal, or square.

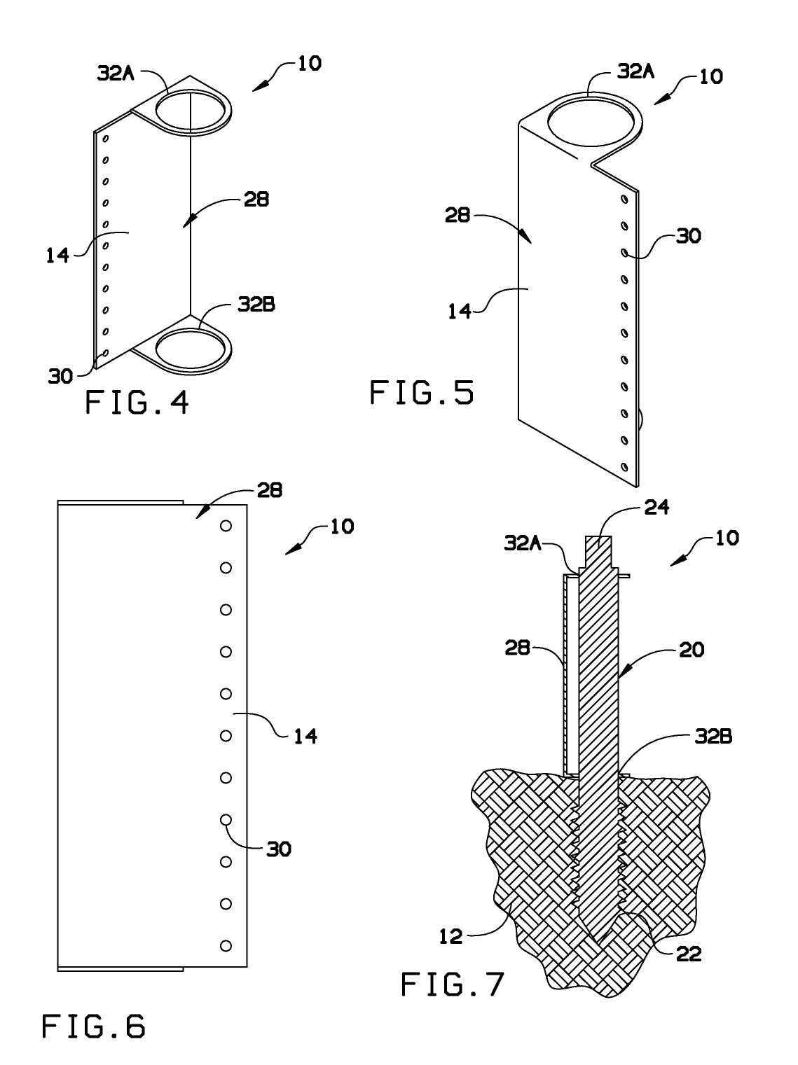

As can be seen in FIGS. 1 and 4-7, the attachment plate 28 may be used to hold the stake 20 against the construction form board 16. The attachment plate 28 may include a body 14 including a first flange 32a on one end and a second flange 32b on the opposite end. The attachment plate 28 may be a one piece plate. The attachment plate 28 may be made of a strong material, for example, steel, stainless steel, aluminum, plastic, and fiber reinforced plastic. The size of the attachment plate 28 may depend on the size of the stake 20. The attachment plate 28 may be made by laser, waterjet, plasma cut, molding, injection molding, or cutting using machining cutting tools.

The flanges 32a, 32b may protrude at a 90 degree angle from the body 14. The size and shape of the flanges 32a, 32b may depend on the size and shape of the stake 20. The second flange 32b may serve as a stopper to prevent the attachment plate 28 from penetrating the ground 12.

A plurality of holes 30 may be located on the edges of the body 14. The holes 30 may be adapted to receive fasteners (not shown) to secure the attachment plate 28 to the construction form board 16. The fasteners (not shown) may be, for example, nails, screws, or bolts. The number of holes 30 may depend on the size of the attachment plate 28.

A reinforcing cap (not shown) may be secured over the polygonal shaped head 24 of the stake 2024. The cap (not shown) may be a removable cap. A user (not shown) may layout, around the construction form board 16, the locations to place the stakes 20. The user may pass the stake 20 through the flanges 32a, 32b of the attachment plate 28. Then, the user may operatively connect a drill driver (not shown) on the polygonal shaped head 24 of the stake 20 and drive the stake 20 into the ground. Then, the user may secured the attachment plate 28 to the construction form board 16 at the desired locations. Finally, the attachment plate 28 may be secured to the construction form board 16 by securing the fastener (not shown) into the holes of the body 14.

The threaded stake system 10 may be also used to secure tents, tarps, or in the landscaping field.

It should be understood, of course, that the foregoing relates to exemplary embodiments of the invention and that modifications may be made without departing from the spirit and scope of the invention as set forth in the following claims.

What is claimed is:

1. A threaded stake system comprising:
a stake including
a shaft having a sharp tip on a first end;
a polygonal shaped head on a second end; and
at least one thread located near the sharp tip;
the stake comprising at least one of metal, plastic, reinforced metal, reinforced plastic, polymer, fiber reinforced polymer, and composite.

2. The threaded stake system according to claim 1, further including an attachment plate, the plate including a body having a first flange on a first end, a second flange on a second end, and a plurality of holes located on edges of the body.

3. The threaded stake system according to claim 2, wherein the stake is designed to be passed through the first flange and the second flange of the plate.

4. The threaded stake system according to claim 2, wherein the plate comprising at least one of steel, stainless steel, aluminum, and plastic.

5. The threaded stake system according to claim 1, wherein the polygonal shaped head is adapted to be used with a drill drive.

6. The threaded stake system according to claim 1, wherein the polygonal shaped head has a shape of a hexagon, pentagon, or square.

7. The threaded stake system according to claim 1, wherein the first flange and the second flange protrude at a 90 degree angle from the body.

8. The threaded stake system according to claim 1, further including a reinforcing cap secured near the polygonal shaped head.
